(19) United States
(12) Patent Application Publication
(10) Pub. No.: US 2013/0183591 A1
(43) Pub. Date: Jul. 18, 2013

(54) METAL-AIR BATTERY AND METHODS FOR FORMING IMPROVED METAL-AIR BATTERIES

(71) Applicant: Richard M. Dickson, Kirkland, WA (US)

(72) Inventor: Richard M. Dickson, Kirkland, WA (US)

(21) Appl. No.: 13/446,884

(22) Filed: Apr. 13, 2012

Related U.S. Application Data
(60) Provisional application No. 61/631,900, filed on Jan. 13, 2012.

(51) Int. Cl. H01M 8/22; H01M 8/00; H01M 4/36

(52) U.S. Cl. 429/405; 429/407; 429/535

(57) ABSTRACT

Examples of metal air batteries are described which may include an anode, provided in contact with an electrolyte, a porous matrix provided adjacent to the electrolyte, and a gas-permeable polymer membrane disposed on an exterior surface of the porous matrix. The gas-permeable membrane may be configured to allow a selected gas to pass through the membrane while preventing selected other gases or liquids from passing through the membrane. Methods according to examples described herein may include providing a metal anode in contact with an electrolyte, providing a porous cathode adjacent to the electrolyte, and enclosing an exterior portion of the porous cathode with a selectively permeable membrane, such that in use, oxygen may be allowed to pass through the gas-permeable membrane in a direction from the cathode to the anode, while water is prevented from passing through the gas-permeable membrane to prevent leakage and/or evaporation of the battery electrolyte.

### CROSS-REFERENCE TO RELATED APPLICATION(S)

This application claims the benefit of the filing date of provisional Ser. No. 61/631,900, filed Jan. 13, 2012, which provisional application is incorporated herein in its entirety, for any purpose.

### TECHNICAL FIELD

This application relates to metal-air batteries and methods for forming metal-air batteries.

### BACKGROUND OF THE INVENTION

Metal-air batteries are batteries which use oxygen, typically oxygen from the ambient air, to oxidize a metal at the anode of the battery generating electrical current. However, metal-air batteries known in the art typically include containment structures which may be used to separate certain components of the battery from others, and/or provide a leak proof design. These rigid and often bulky containment structures may impose numerous design limitations on metal-air batteries known in the art. For example, containment structures of conventional-metal air batteries may add structural inflexibility, imposing geometric limitations on the overall design, and/or limiting the intake of oxygen thereby limiting overall power output of the batteries. Containment structure may also add weight and additional material, thereby increasing the cost of manufacture and use of such batteries and limiting the potential for proliferation of metal-air battery technologies. Metal-air batteries known in the art often require the use of expensive materials, such as PTFE for example, less costly alternatives of which may be provided for in the present disclosure.

### BRIEF DESCRIPTION OF THE DRAWINGS

The present invention will now be described, by way of example, with reference to the attached figures, of which:

FIG. 1 is a cross-sectional illustration of an example metal-air battery according to embodiments of the present invention.

FIG. 2 is an illustration of another example of metal-air batteries according to embodiments of the present invention.

FIG. 3 is an illustration of a method of forming metal-air batteries according to embodiments of the present invention.

### DETAILED DESCRIPTION

Certain details are set forth below to provide a sufficient understanding of embodiments of the invention. However, it will be clear to one skilled in the art that embodiments of the invention may be practiced without various of these particular details. In some instances, well-known structures, chemical components and reactions, molecules and materials, have not been shown in detail in order to avoid unnecessarily obscuring the described embodiments of the invention.

Examples of metal-air batteries according to the present invention may include an anode, which is provided in contact with an electrolyte, a porous cathode provided adjacent to the electrolyte, and a polymer membrane disposed exterior to the anode-cathode assembly. The polymer membrane may be configured to allow a selected gas to pass through the membrane while preventing a selected liquid or other gasses from passing through the membrane, some advantages of which will be discussed in more detail below.

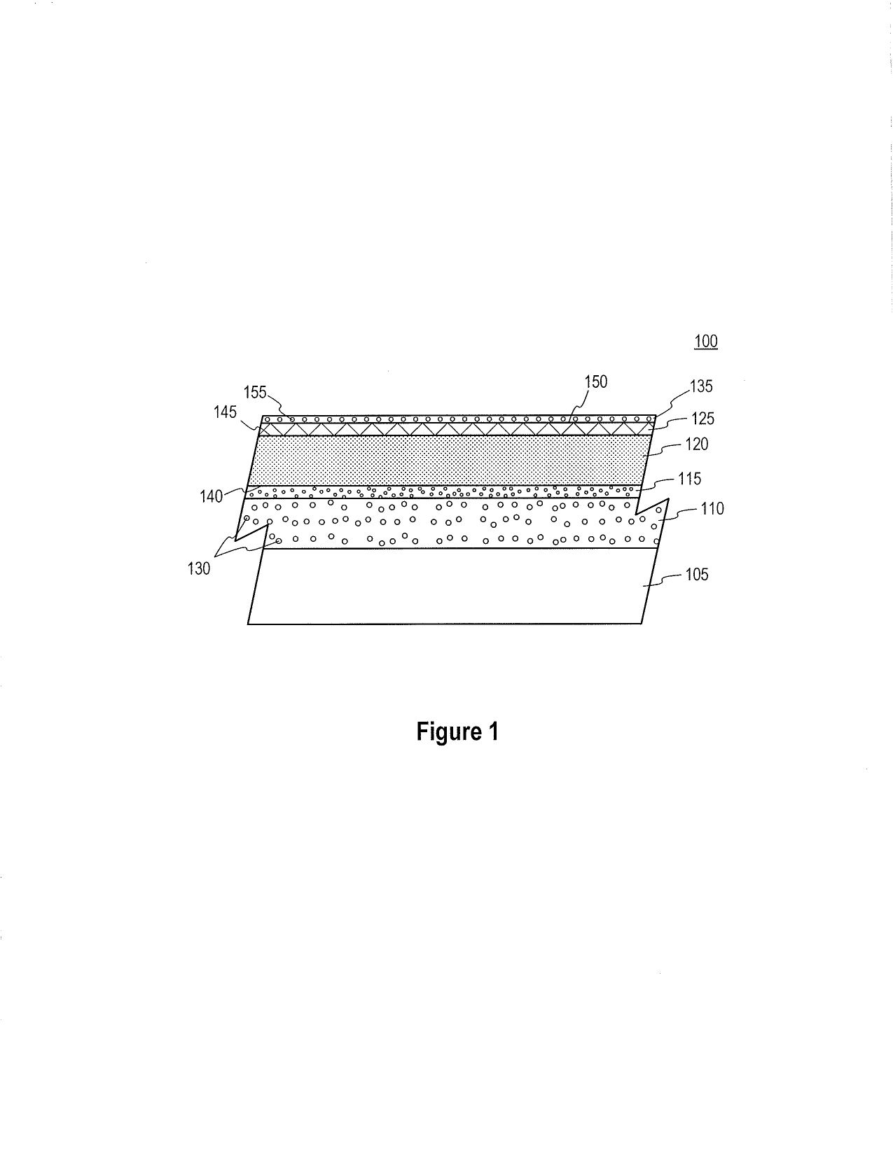

FIG. 1 shows a cross-sectional illustration of an exemplary metal-air battery according to embodiments of the present invention. The metal-air battery 100 may include an anode 105, an electrolyte 110, an air cathode 120, and a polymer membrane 135. In some examples, an optional coating or membrane 115 may be provided between the electrolyte 110 and the air cathode 120, a catalyst 125 may be provided at the air cathode 120, and certain additives 130 may be included in the electrolyte, as will be further described.

The anode 105 may be formed from any reactive metal, for example Aluminum, Zinc, Lithium, or other suitable materials known in the art. The anode 102 may be provided in substantially any form (e.g., a solid, a powder, a porous structure, or others) and may have any form factor that may be desirable for the particular application. That is, the cross-sectional profile in FIG. 1 is intended to show the relative arrangements of components (e.g., anode, electrolyte, cathode, etc.) and is not to be viewed as limiting the overall geometrical arrangements possible according to the examples described.

Referring back to FIG. 1, the anode 105 may be provided as a solid block of material, or it may be configured as a plurality of spaced-apart plates of the selected material. In some examples, the anode 105 may be provided as a metallic powder, a pellet of metallic particles or beads of varying sized, or any other porous structure, such as a metallic matrix of the desired anode material. Solid or porous metals suitable for use as an anode may be easily obtained by conventional means. For example, porous structures or matrices may be formed according to any methods known in the art, including sintering or rapid prototyping techniques, as well as fabrication techniques for forming metal matrix composites. As will be described further below and as will be appreciated in light of the present disclosure, the use of a gas-permeable membrane 125 as the exterior enclosure of the battery cell may advantageously allow for a great variety of diverse shapes and configurations of metal-air battery cells implemented according to the present disclosure.

The electrolyte 110 may be selected as may be appropriate for the specific material used at the anode 105 in a particular application. In some examples, the electrolyte 110 may be a solution of any suitable base, acid, or salt, configured to facilitate the oxidation of the anode 105. In some examples, the electrolyte 110 may be provided as a liquid (e.g., an aqueous solution), or it may be provided as a gel layer (e.g., a hydroponic gel electrolyte). In some examples, the electrolyte 110 may include, without being limited to, potassium, sodium, calcium, and/or other ions. In examples in which the anode 105 is provided in powder form, the anode 105 may be immersed in the electrolyte 110 to form a paste. In some examples, in which the anode 105 is implemented as a porous structure (e.g., a matrix or a pellet of metallic or metal-plated beads), the electrolyte 110 may be disposed such that it permeates the pores of the anode 105 providing an increased surface area contact.

In some examples, a separation membrane 115 may be provided between the electrolyte/anode assembly and the air cathode. The membrane 115 may be selected to be suitable for gas and ion exchange. In some examples, the membrane 115 may be a porous membrane and have suitable porosity to prevent electrolyte from evaporating or leaking out of the interior of the battery. In some examples, such as where the anode may be implemented with limited structural rigidity on its own (e.g., a paste anode or bead pellet anode), the optional membrane 115 may be provided to enclose and/or contain the anode/electrolyte assembly. As will be appreciated, membrane 115, if used, may be selectively tailored to offer the desired permeability (e.g., gas/liquid and/or ion exchange as needed) and the necessary structural functionality required to maintain a desired shape of the battery. Thus, in some examples, a membrane 115 suitable for gas and ion exchange may be provided between the electrolyte/anode assembly and the air cathode.

As is known in the art, metal-air batteries may offer certain efficiencies, for example based on the fact that the oxygen needed to complete the chemical reactions resulting in flow of electrons need not be stored in the battery enclosure but may instead be obtained from the surrounding air. Typically, power (e.g., electrical energy) is generated through oxidation at the metal anode and reduction of oxygen at the cathode, which is typically provided in contact with a flow of air, thereby inducing a flow of electrons.

In the example in FIG. 1, the battery cell 100 may be provided with a porous structure 120, which may for example be a graphite matrix or other porous carbon structure. An interior surface 140 of the structure 120 may be disposed adjacent to the electrolyte 110 and an exterior surface 145 of the structure 120 may generally form the outer boundary of the cell 100. The porous structure 120 and oxygen reduction reaction taking place there may function as the air cathode of the battery cell 100. In some examples, a catalyst, such as Manganese Oxide (Mn₃O₄) for example, may be provided at the cathode to further enhance the chemical reactions taking place at the cathode 120. Any suitable catalyst known in the art may of course be used.

In some examples, the air cathode 120 may include a noble metal layer which may be provided on one or more surfaces of the cathode 120. For example, the noble metal layer may be provided on the surface 145, or it may be provided on interstitial surfaces of the carbon matrix. Any known method for depositing particles or thin layers of a material may be used for providing the noble metal layer on the cathode.

In some examples, the air cathode 120 may be provided with a structure 125, which may be a catalyst layer or a catalyst-coated mesh structure. The structure 125 may be a metal mesh or a polymer mesh. In some examples, the mesh may be formed of a noble metal, for example silver. In some examples, the mesh 125 may be a metal coated nylon mesh. Any other suitable catalyst may be used to further enhance the reduction of oxygen at the air cathode. In some examples, the catalyst may be coated directly onto the porous cathode 120, or it may be provided as an additional component 125, which may be attached to the cathode, for example by gluing with an oxygen permeable adhesive. In some examples, the structure 125 may be a plurality of metal-coated particles, which are bonded to the cathode 120 using any suitable oxygen permeable adhesives known in the art. In some examples, the cathode may be formed by bonding together a plurality of carbon particles and metal-coated particles. As will be appreciated, using a nylon mesh or other high porosity structure at 125, only a small amount of the typically expensive catalyst material need be provided, thus reducing the cost of the battery 100 as compared to other possible configurations. In some examples, the structure 125 may be provided on the opposite side of the porous cathode 120 (e.g., adjacent the interior surface 140).

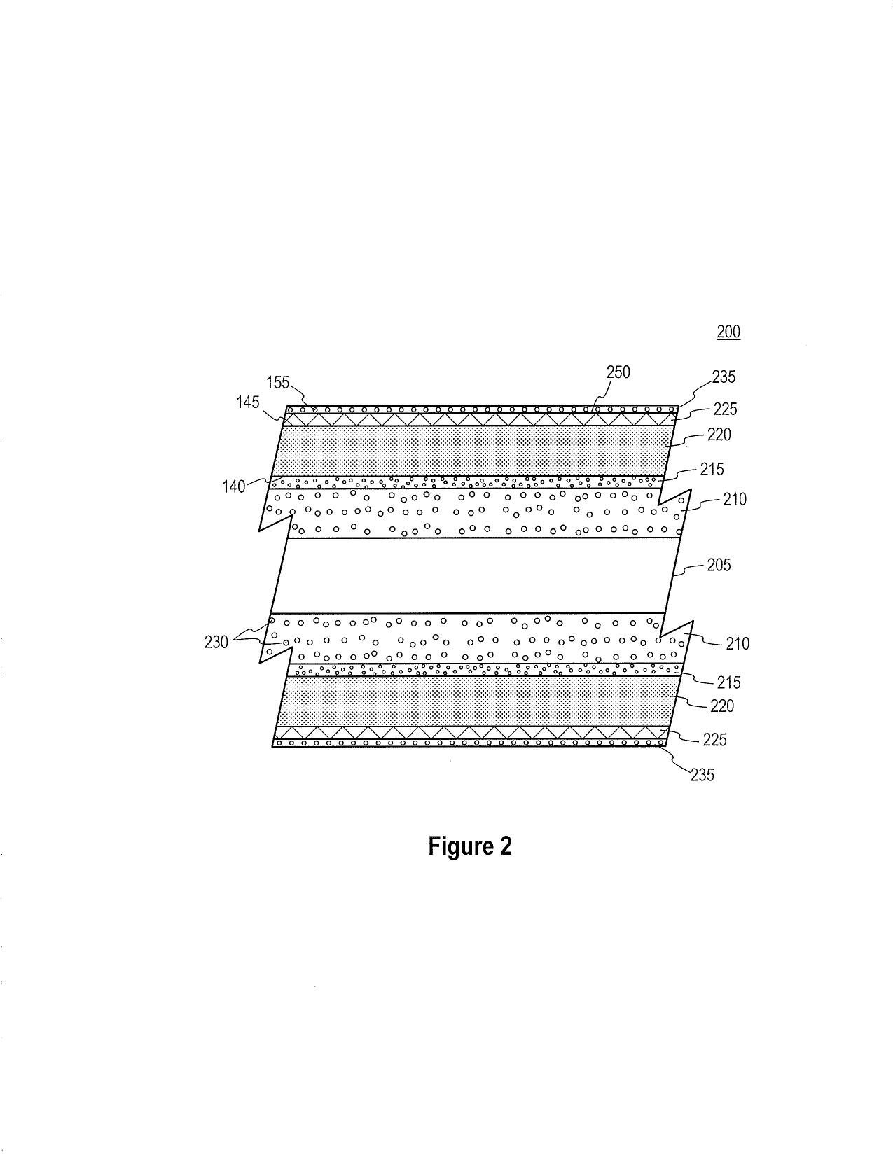

As mentioned, battery cells according to the present disclosure may include a polymer membrane 135, which may be a selectively permeable membrane and may be disposed about an outer surface of the anode-cathode assembly. In some examples, the membrane 135 may be provided along an outer surface 150 of the battery cell 100. In some examples, the surface 145 may be the outer surface of the battery cell. In some examples, the membrane 135 may extend around some or all of the perimeter of battery cell 100. As can be appreciated, a double-sided configuration may be implemented, where a central anode is immersed and/or surrounded by an electrolyte and air cathode, as will be further described in reference to FIG. 2

In some examples, the membrane 135 may be a gas-permeable membrane. For example, it may allow oxygen, or other gases, to pass through the membrane 135, while preventing liquids, such as water, from penetrating the membrane 135. In some examples, the membrane may be porous, and the pore size may be based, in part, on the molecular size of molecules desired to be blocked or pass through the membrane. In some examples, the permeability of the membrane 135 may be tailored to allow certain molecules to penetrate the membrane while certain other molecules are to be prevented from penetrating the membrane. In some examples, the membrane 135 may be coated with or include a hydrophobic material. In some examples, the membrane 135 may be formed from a polymer, such as ethylene for example.

As can be appreciated, the membrane 135 may be selected to have a thickness 155 as may be suited for the particular application. In some examples, where a larger battery cell is desired a thicker and/or more durable membrane 135 may be desirable. In some examples, as in the case of miniature battery cells, the membrane may be several microns thick. In some examples, the thickness 155 of the membrane may be tailored to vary the rate of oxygen delivery into the interior of the battery. In some applications the membrane may be a constant thickness throughout or it may have variable thickness. In preferred embodiments, the membrane 135 may comprise an oxygen-permeable ethylene plastic. As described herein, the oxygen-permeable ethylene plastic may be disposed between the ambient air and the air cathode 120 to facilitate gas exchange at the cathode 120.

The membrane 135 may be a flexible membrane, which may be used to wrap the components of the battery cell (e.g., 105, 110, 120, etc) as described herein. If desired, the example battery cell 100, after being wrapped with the membrane 135, may be placed in a container or casing (not shown), however as described, in some examples no additional enclosure may be required other than the wrapping/enclosure supplied by the membrane 135. In examples of the present invention, the membrane 135 alone may be used to define and maintain the shape of the battery cell. In some examples, multiple layers of a membrane may be used, and the permeability properties and/or thickness of the single or each of the multiple layers of membrane may be tailored to achieve a desired overall performance (both structurally and in terms of permeability) of the membrane 135. As will be appreciated by those skilled in the art, other components of metal-air batteries known in the art may also be included in this exemplary configuration without departing from the scope of the present invention.

For illustration purposes, and with reference to FIG. 1, the operation of an example battery cell according to the present invention will be described. In the example of FIG. 1, metal ions may be are released from the reactive metal (e.g., aluminum, zinc, etc.) at the anode 105 via the chemical reaction with the electrolyte 110, which as described may be in the form of a liquid or a gel, as examples. The electrolyte may include additives 130 for enhancing the operation of the batteries, as will be further described. The free electrons may be transported to the porous structure 120, which may be a graphite matrix or other carbon structure, and in some cases passing through the optional coating or membrane 115 provided on a surface 140 of the porous cathode 120. Oxygen from the ambient air (e.g., oxygen exterior to the battery cell 100) may enter the interior of the battery cell 100 through the membrane 135 which may cover part of or all of the exterior surfaces 150 of the battery cell 100. The oxygen atoms passing into the battery cell 100 may combine with the metal electrons at the cathode 120, and water ions may be released to produce metal hydroxide, generating electricity in the process.

FIG. 2 shows a cross-sectional illustration of another example of a metal-air battery cell according to the present invention. The battery cell 200 in FIG. 2 is shown to have a double-sided configuration in that a central anode 205 is surrounded by or immersed in the electrolyte 210. The battery cell 200 may also include an air cathode 220, which may be implemented as a porous structure as described herein, and which may be coated with or provided with any suitable catalyst, such as a noble metal. In some examples, the catalyst may be provided on a mesh 225, or the mesh 225 may itself be made of a noble metal to catalyze the half reaction at the cathode. The battery cell may be wrapped/enclosed in a selectively permeable outer membrane 235.

Similar to the example in FIG. 1, the anode 205 may be formed from any reactive metal, such as Aluminum, Zinc, or others. The anode 205, which in the present example is a central anode 205 (e.g., it is surrounded on some or all sides by the electrolyte 210 and air cathode 220) may be implemented in substantially any shape or provided in any form. In some examples, the anode 205 may be a solid material having a cylindrical, spherical, rectangular, or other configuration. In some examples, anode 205 may be in the form of a powder, or larger sized metallic particles, or it may be configured as a porous structure, having regularly or irregularly spaced interstitial spaces therein. As will be understood, any suitable form factors described and/or appreciated in light of the present disclosure may be used.

The electrolyte 210 may be any suitable electrolyte selected for the particular metal used as the anode 205. In some examples, and as previously described, the electrolyte 210 may be provided as an liquid (e.g., an aqueous solution of KOH), or it may be provided in gel form (e.g. a hydroponic gel electrolyte). The electrolyte 210 may be a mixture of any suitable element such as potassium, sodium, or others as are know in the art. Additives 230 may be added to the electrolyte to enhance the performance of the metal-air battery 200 as further described. In some examples, an optional separation membrane 215 may be included at a boundary between the electrolyte and the air cathode. The separation membrane 215 may be a porous membrane having suitable permeability, and may for example be made of the same material as the outer membrane 235 tailored specifically for the desired permeability.

The air cathode 220, as described herein may be a porous structure which is configured to receive oxygen from the exterior of the battery and catalyze the reaction with the oxygen at the cathode. The cathode 220 may have any suitable shape and porosity to provide sufficient flow of oxygen into the battery cell. As described, a suitable catalyst, for example Mn₃O₄ may be coated onto the porous cathode 220 or provided as an additional layer. In some examples, other components to further enhance the chemical reactions may include mesh structure 225, for example a silver mesh or any other mesh made of or coated with one or more noble metals.

The battery cell 200 may include a selectively permeable membrane 235, which may be used to wrap some or all of the outer surfaces of the battery cell 200. One or more layers or wrappings of the membrane 235 may be provided. The selectively permeable membrane 235 may be tailored to allow certain gases, such as oxygen for example, to pass through the membrane 235, while preventing certain other gases, such as carbon dioxide and/or liquids, such as water, from passing through the membrane 235. In some examples, the selectively permeable membrane 235 may be coated with or include a hydrophobic material. In some examples, the membrane 235 may be formed from a polymer, such as ethylene for example. As will be appreciated by those skilled in the art, other components may be added or some components removed from the metal-air batteries described herein without departing from the scope of the present invention.

In a preferred example of a metal-air battery cell 200 according to the present invention, the battery cell 200 may include an oxygen-permeable ethylene membrane 235 with a zinc anode 205. By using an oxygen-permeable ethylene as a tailored outer membrane, oxygen can be allowed in from all directions while retaining all non-gaseous molecules inside the battery cell 200. Exposing more cell surface area to oxygen penetration may improve the performance of the cell, especially in low air flow environments.

Furthermore, unlike conventional metal-air cells, which typically are provided in cubic or rectangular arrangements, using a flexible plastic membrane 235, for example a membrane comprising a polymer material, as the enclosure may allow for metal-air cells according to the present disclosure to be implemented in a variety of form factors. In some examples, this can be achieved by wrapping, using the flexible polymer membrane 235, some or all of the exterior surface 250 of the cathode 220, which in the example in FIG. 2 is disposed about the central anode 205 and electrolyte 210. Such flexibility with respect to the geometric configuration of the battery cell may allow for maximizing space requirements and thus optimizing space usage in various application, for example applications which impose space or geometric limitations on the battery design.

As discussed, the selectively permeable membrane 235 may be further tailored increase intake of certain gases, and/or to reduce intake of gasses harmful to the battery cell's chemistry. For example, in the case of a Zinc-Air cell, reducing carbon dioxide (CO₂) intake may reduce degradation of an electrolyte commonly used with a Zinc anode, aqueous potassium hydroxide (KOH). Furthermore, providing the outer boundary of the battery cell 200 with a selectively permeable membrane, for example a membrane which prevents liquids from passing through the membrane, may minimize or eliminate undesirable evaporation of liquids from within the cell. Aluminum, Zinc and Magnesium cells commonly use liquid electrolytes, and loss of water from the electrolyte may degrade the performance of the cell or render it entirely inoperable. Thus, in some examples, the membrane 235 may have selective permeability such that oxygen is allowed to pass through the membrane, while CO₂ and/or water are prevented from passing through the membrane.

Other advantages that will be appreciated in light of the present disclosure include the ability to form metal-air battery cells having substantially any desired shape. Some examples may include flat or rolled battery arrangements. Furthermore, the flexibility of form obtainable using examples according to the present disclosure may also lead to less amount of material being needed and used for the manufacture of metal-air battery cells, which may offer comparable power output of larger conventional metal-air battery cells.

As described herein, metal-air batteries may offer numerous advantages, including the low cost of producing electricity. As previously described, because oxygen at the cathode can be obtained from the surrounding air and need not be stored/enclosed within the battery's structure, metal-air batteries can pack additional reactive material at the anode and thereby increase overall power output of the battery. Furthermore, as in the case of an aluminum-air battery for example, the aluminum anode may provide high electromagnetic density and may be relatively abundant and inexpensive. Higher purity aluminum may offer higher energy density as it may increase the reactive material available for oxidation and release of electrons. However, a key problem with the use of higher purity anodes may be their tendency to be corroded by the electrolyte leading to shorter life of the battery. As can be appreciated, oxidation of an aluminum anode, for example, may cause the formation of aluminum hydroxide to form on surface of the anode, which can act as a corrosive blocking agent preventing exchange of negative ions from the aluminum to the air cathode via the electrolyte.

In some examples, additives may be added to the electrolyte to further enhance the performance of the metal-air batteries, as described herein. In some examples of the present invention, corrosion inhibitors may be provided, for example by adding such corrosion inhibitors to the electrolyte 210 of the metal-air battery 200. In some examples corrosion inhibitor may serve to reduce corrosion on the anode, and thus enhance battery power and longevity.

As previously described, the electrolyte 210 may be provided as an aqueous solution, or it may be provided as a gel in examples batteries having a metal anode (for example, Aluminum). In some examples, the electrolyte 210 may be a mixture of any suitable salts, other bases, or acids. In some examples, the electrolyte 210 may include potassium hydroxide (KOH) provided in a solution with distilled water or with a hydroponic gel (HPG). In examples according to the present disclosure, corrosion inhibitor 230 may include sodium hexametaphosphate (SHMP), which is non-flammable, non-poisonous, and relatively environmentally benign. In some examples, a certain concentration of SHMP may be provided in an aqueous solution of KOH. In some examples, the corrosion inhibitor may be provided at a concentration of about 0.006 moles to about 0.067 moles, and preferably at 0.0336 moles. As can be appreciated, the specific moles of performance enhancing additive can be tailored based on the specific material used at the anode and/or the appropriate electrolyte for the application.

Test results of examples according to the present disclosure demonstrate peak power generation of about 0.5 volts with a 28 ohm resistor load for almost 10.6 hours, continuing to generate power until 12.98 hours after which the full aluminum anode was used up in the reaction. This is in contrast with metal-air batteries using similar concentration of electrolyte without corrosion inhibitors (e.g., KOH electrolyte at 1.2 molarity measured at 28 ohm resistor load), which may generate about 0.5 volts for about 2.9 hours, and stopping electricity production after about 5.3 hours. As can be appreciated, using examples of the present disclosure may offer as much as 3.7 times longer operational time at peak power (e.g. 0.5 volts, in this example) as compared to electrolytes in conventional metal-air batteries.

In a specific example, an electrolyte including 0.5 liters of distilled fresh water, 1.2 moles of KOH flakes (e.g., approximately 36 grams) dissolved in the water, and 0.0336 moles (e.g., approximately 11 grams) of SHMP or other battery performance enhancing additives also dissolved in the water solution, was provided. In other examples, hydroponic gel having similar concentration as described may alternatively be used. The electrolyte may be provided in a aluminum-air battery according to the present disclosure, which may include an aluminum plate at the anode, for example. The cathode may be include activated carbon charcoal, which may be provided in contact with the electrolyte solution. The example battery may be operable to generate peak sustainable power steadily for about 10.6 hours, or about 82% of the life of the example battery cell. By contrast conventional batteries of the kind may generate peak power for about 2.9 hours or approximately 27% of the time of the example described.

Corrosion inhibitors, such as SHMP for example, may function as an effective dispersion at selected molarity, (e.g., a molarity of about 0.034), and may thereby accelerate the dispersal of the anode's metal ions throughout the electrolyte solution. Using corrosion inhibitors according to the present disclosure may result in a relatively smooth power curve or “burn rate” of the metal anode, which can be aluminum for example. The concentration of the corrosion inhibitors may be tailored to provide optimal dispersion as may be suitable for the particular metal anode and electrolyte.

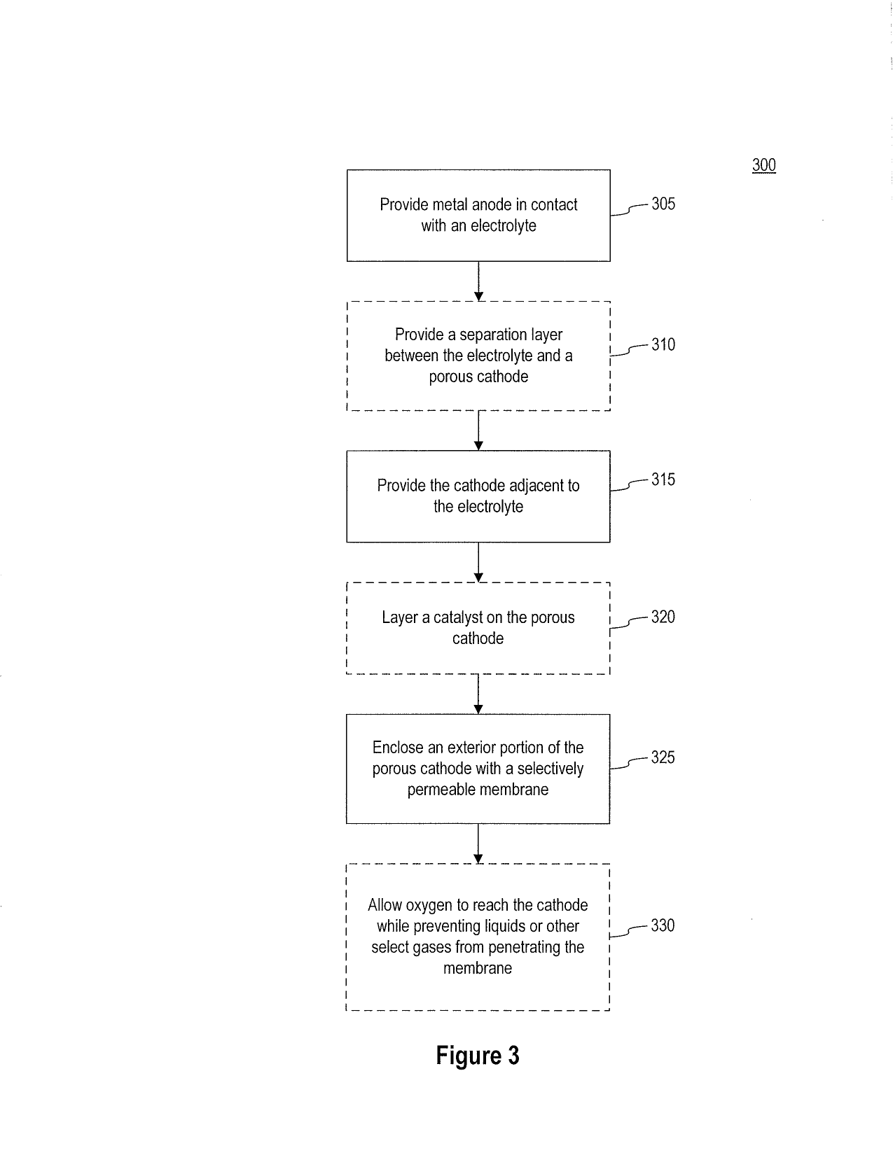

FIG. 3 is a flow diagram depicting an example method according to the present disclosure. Methods according to examples described herein may include the steps of providing a metal anode in contact with an electrolyte (as shown in box 305), providing a porous cathode adjacent to the electrolyte (as shown in box 315), and enclosing an exterior portion of the porous cathode with a selectively permeable membrane (as shown in box 325).

In some examples, the step of providing a metal anode in contact with the electrolyte may include immersing a metal, such as zinc or aluminum as examples, into an aqueous solution. In some examples, the step of providing a metal anode in contact with the electrolyte may include providing a layer of gel electrolyte on a surface of the anode. The electrolyte may be any suitable electrolyte as described herein or known in the art, such as for example potassium hydroxide (KOH). In some examples, the method may further include adding sodium hexametaphosphate (SHMP) or other battery performance enhancing additives to the electrolyte at concentrations selected to enhance the performance of the battery. In some examples, an additive of SHMP at a concentration of about 0.034 moles may be added to the electrolyte to inhibit corrosion of the metal anode as described herein.

The step of providing a porous cathode adjacent to the electrolyte may include placing a porous structure, such as a carbon or graphite matrix or a plurality of loose carbon or graphite particles adjacent to the electrolyte. In some examples, where loose carbon is used, the carbon material may be wrapped in the selectively permeable membrane. In some examples, the step of providing a porous cathode adjacent to the electrolyte may include bonding silver coated particles to a carbon matrix using oxygen permeable adhesive. Furthermore, the mixture of carbon particles with silver coated on said particles may be wrapped using the gas-permeable membrane described herein.

As will be appreciated some of the steps described may be performed out of order and or excluded altogether. Additional optional steps may of course be included without departing from the scope of the present invention. In some examples, as shown in box 310, the method may further include providing a separation layer or membrane between the electrolyte and the porous cathode as described herein. This may be appropriate when a non-structurally rigid form is used at the anode and/or when the anode comprises a material which may advantageously be isolated from the electrolyte and/or the cathode. In some examples, a catalyst may be provided at the cathode, such as by coating the cathode with a noble metal or by providing a mesh structure adjacent to the cathode, as shown in box 320. Many suitable catalysts may be used as appropriate for the particular application.

In some examples, the step of enclosing an exterior portion of the porous cathode, as shown in box 325, may include wrapping at least a portion of the metal-air battery cell with an oxygen-permeable ethylene film. In this manner an exterior surface of the battery cell may be wrapped in a flexible outer membrane which may allow for gas exchange between the cathode and the ambient air, while preventing the outflow or evaporation of liquids from the interior of the battery. The selectively permeable membrane may also be configured to exclude certain other gases from penetrating the membrane, such as for example carbon dioxide. Accordingly, example methods according to the present disclosure may further include the step of allowing oxygen to reach the cathode while preventing liquids or other select gasses from penetrating the membrane, as shown in box 330.

An example method of using gas permeable membrane for gas exchange with the air cathode of a metal-air battery, may include providing a sheet of an oxygen-permeable ethylene between the air-cathode and the ambient air, allowing oxygen to pass through the gas-permeable membrane in a direction from the cathode to the anode, preventing water from passing through the gas-permeable membrane in a direction from the anode to the cathode, and generating a flow of electrons between the anode and the cathode of the metal-air battery. In some examples, the method may further include the steps of preventing carbon dioxide from passing through the membrane.

From the foregoing it will be appreciated that, although specific embodiments of the invention have been described herein for purposes of illustration, various modifications may be made without deviating from the spirit and scope of the invention.

What is claimed is:

1. A metal-air battery comprising:
an anode provided in contact with an electrolyte;
a porous cathode disposed adjacent to the electrolyte and forming, with the anode, an anode-cathode assembly; and
a polymer membrane disposed exterior to the anode-cathode assembly, wherein the polymer membrane is configured to allow a first gas to pass through the membrane while preventing a second gas or a liquid from passing through the membrane.

2. The battery of claim 1, wherein the polymer membrane is a gas-permeable membrane configured to allow oxygen to pass through the membrane while preventing water from passing through the membrane.

3. The battery of claim 1, wherein the polymer membrane is a gas-permeable membrane configured to allow oxygen to pass through the membrane while preventing carbon dioxide from passing through the membrane.

4. The battery of claim 1, wherein the polymer membrane is an oxygen-permeable film made from ethylene plastic.

5. The battery of claim 1, wherein the polymer membrane is configured to maintain the anode-cathode assembly in a desired shape.

6. The battery of claim 1, wherein the polymer membrane is used to wrap the anode-cathode assembly thereby enclosing the anode, electrode and cathode therewithin.

7. The battery of claim 1, wherein the anode is immersed in the electrolyte such that the electrolyte surrounds a perimeter of the anode.

8. The battery of claim 1, wherein the porous cathode comprises a carbon matrix and a noble metal layer provided on one of the carbon matrix or a mesh material disposed adjacent to the carbon matrix.

9. The battery of claim 1, wherein the porous cathode comprises a porous carbon structure having metal-coated particles bonded to the carbon structure.

10. The battery of claim 1, wherein the porous cathode comprises a matrix of silver coated particles bonded to carbon particles using oxygen permeable adhesive.

11. A metal-air battery comprising:
a metal anode;
an electrolyte provided in contact with the metal anode, wherein said electrolyte includes an additive selected to inhibit corrosion of the metal anode;
a porous cathode disposed adjacent to the electrolyte opposite the metal anode,
wherein the anode, the electrolyte, and the cathode form a battery cell assembly, and wherein at least a portion of an outer surface of the assembly is wrapped with a gas-permeable membrane configured to allow a first gas to pass through the membrane while preventing a liquid or a second gas different from the first gas from passing through the membrane.

12. The battery of claim 11, wherein the gas-permeable membrane comprises oxygen-permeable ethylene plastic, and wherein the additive includes sodium hexametaphosphate (SHMP).

13. The battery of claim 12, wherein the sodium hexametaphosphate (SHMP) is provided at a concentration of about .034 moles.

14. A method of forming a metal-air battery, the method comprising:
providing a metal anode in contact with an electrolyte;
providing a porous cathode adjacent to the electrolyte to form a battery-cell assembly; and
enclosing an exterior of the battery-cell assembly with a gas-permeable membrane.

15. The method of claim 14, wherein said providing a metal anode in contact with an electrolyte includes layering aqueous solution or gel of the electrolyte on a surface of the metal anode.

16. The method of claim 14, wherein said providing a metal anode includes immersing zinc into an aqueous solution or gel comprising potassium hydroxide.

17. The method of claim 14, wherein said enclosing includes wrapping the exterior surface of the battery-cell assembly with an oxygen-permeable ethylene film.

18. The method of claim 14, wherein said enclosing comprises forming the battery into a desired shape using the gas-permeable membrane.

19. The method of claim 14, wherein the porous cathode comprises a carbon matrix, the method further comprising bonding metal-coated particles to the carbon matrix using oxygen permeable adhesive prior to said providing the porous cathode adjacent to the electrolyte.

20. The method of claim 14, further comprising providing an additive to the electrolyte at a concentration selected to inhibit corrosion of the metal anode.
